(19) United States
(12) Patent Application Publication
(10) Pub. No.: US 2025/0085693 A1
(43) Pub. Date: Mar. 13, 2025

(54) CONTROL DEVICE

(71) Applicant: FANUC CORPORATION, Minamitsuru-gun, Yamanashi (JP)

(72) Inventor: Yasushi HAYASHI, Yamanashi (JP)

(21) Appl. No.: 18/289,783

(22) PCT Filed: Jun. 21, 2021
(86) PCT No.: PCT/JP2021/023476

§ 371 Date: Jun. 4, 2024

(51) Int. Cl. G05B 19/4155

(52) U.S. Cl. CPC G05B 19/4155; G05B 2219/35252

(57) ABSTRACT

The present invention reduces the risk that an unintended operation will be executed when an operator changes data pertaining to machine control. This control device comprises: an input unit for receiving data pertaining to machine control from an external unit; a changed function extraction unit for assessing a function relating to the data received by the input unit; a function limitation unit for selecting one or more function limitations, and executing the selected one or more function limitations, on the basis of a changed function notification indicating the result of assessment by the changed function extraction unit; and a function execution unit for executing the machine control.

### TECHNICAL FIELD

The present invention relates to a control device.

### BACKGROUND ART

Conventionally, when changing data related to machine control, such as parameters, ladder programs, and machining programs, the operator would refer to instruction manuals and actually operate the function related to the changed data, or execute a pre-prepared test plan, in order to check whether the operation is running as expected by the operator.

For example, there is a known technique which simulates a machining program to be executed, and determines if interference would arise between the workpiece to be processed and each virtual tool, and when determining that interference would arise, the B-axis angle of the virtual tool stored in the tool data is shifted away from the workpiece within the range of the maximum shift amount set. Refer to Patent Document 1, for instance.
Patent Document 1: Japanese Unexamined Patent Application, Publication No. 2002-79428

### DISCLOSURE OF THE INVENTION

### Problems to be Solved by the Invention

The content of simulation, test, execution, and verification all rely on the operator's judgement, which may involve a risk of causing operations unexpected by the operator, due to factors such as failure or omission in verifying the operation.

As a result of the unexpected operations, defective machining or malfunction of the safety functions may be anticipated.

It takes a considerable amount of time for the operator to accurately extract the data related to machine control and the functions to be affected by such data.

Therefore, the risk of executing unexpected operations is desired to be reduced when the operator changes the data related to machine control.

### Means for Solving the Problems

One aspect of the control device of the present disclosure includes: an input unit configured to externally receive data related to machine control; a changed-function extraction unit configured to determine a function related to the data received by the input unit; a function restriction unit configured to select one or more function restrictions, based on a changed-function notification indicating a result determination by the changed-function extraction unit, and execute the function restrictions selected; and a function execution unit configured to execute the machine control.

### Effects of the Invention

According to the one aspect, the risk of executing unexpected operations can be reduced when the operator changes the data related to machine control.

### BRIEF DESCRIPTION OF THE DRAWINGS

FIG. 1 is a functional block diagram illustrating an example of a functional configuration of an automatic test execution system according to a first embodiment;

FIG. 2A is a diagram illustrating an example of a function relationship table;

FIG. 2B is a diagram illustrating an example of a function¥-restriction relationship table;

FIG. 3 is a diagram illustrating an example of a relationship between a shaft speed and a set speed in safety speed limit monitoring;

FIG. 4 is a flowchart illustrating execution processing by the automatic test execution system;

FIG. 5 is a functional block diagram illustrating an example of a functional configuration of a control system according to a second embodiment;

FIG. 6 is a diagram illustrating an example of a display screen displayed on the display unit; and

FIG. 7 is a flowchart illustrating the control processing by a numerical control device 10A.

### PREFERRED MODE FOR CARRYING OUT THE INVENTION

The first and second embodiments will be described in detail with reference to the drawings.

Here, an operator changes data related to machine control, and each embodiment is common in determining the changed function, selecting a function restriction on the changed function, and executing the selected function restriction.

However, in the first embodiment, when canceling the executed function restriction, the control device is connected to a test execution device that manages and executes a test for each function, the test execution device executes the test for each function in response to a changed-function notification from the control device, and the control device cancels the function restriction in response to a function restriction cancelation request from the test execution device indicating that the test result is normal. In contrast, in the second embodiment, the control device displays a changed-function notification including a function restriction and restriction contents, and cancels the function restriction in response to a function restriction cancelation request from the operator, which differs from the first embodiment.

At first, the first embodiment will be described below in detail, then the parts particularly different from the first embodiment in the second embodiment will be described.

### First Embodiment

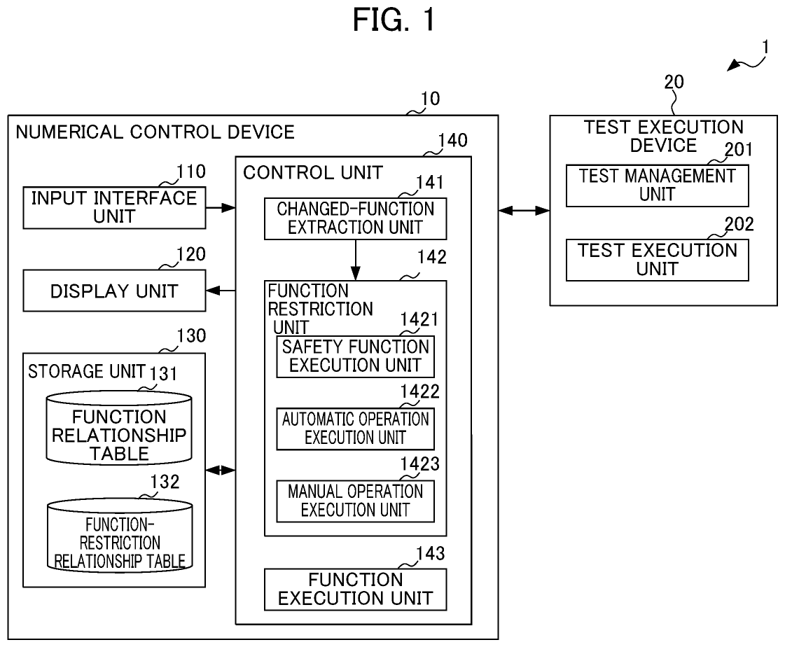

FIG. 1 is a functional block diagram illustrating an example of a functional configuration of an automatic test execution system according to the first embodiment. Here, a numerical control device is illustrated as an example of a control device. However, the present invention is not limited to numerical control devices and can also be applied to robot control devices that control industrial robots, for example.

As illustrated in FIG. 1, the automatic test execution system 1 includes a numerical control device 10 and a test execution device 20.

As illustrated in FIG. 1, the numerical control device 10 and the test execution device 20 may be directly connected to each other via a connection interface (not illustrated) by wire or wirelessly. The numerical control device 10 and the test execution device 20 may be connected to each other via a network such as LAN (Local Area Network) or the Internet. In this case, the numerical control device 10 and the test execution device 20 includes a communication unit (not illustrated) for mutual communication via such connections. As will be described later, the numerical control device 10 may be configured to include the test execution device 20.

### <Test Execution Device 20>

The test execution device 20 is, for example, a computer or the like.

As illustrated in FIG. 1, the test execution device 20 includes a test management unit 201 and a test execution unit 202.

The test execution device 20 includes an arithmetic processing unit such as a CPU (Central Processing Unit) (not illustrated) to implement the operations of the functional blocks in FIG. 1. The test execution device 20 also includes auxiliary storage devices such as ROM (Read Only Memory) or HDD (Hard Disk Drive) (not illustrated) for storing various control programs, and a main storage device such as RAM (Random Access Memory) (not illustrated) for temporarily storing data required for the arithmetic processing unit to execute the program.

In the test execution device 20, the arithmetic processing unit reads OS and application software from the auxiliary storage device, and develops the read OS and application software into the main storage device, while executing arithmetic processing based on these OS and application software. Based on the results of the calculation, the test execution device 20 controls each hardware. As a result, the processing by the functional blocks in FIG. 1 is implemented. In other words, the test execution device 20 can be implemented by hardware and software in collaboration.

For example, in the numerical control device 10 described later, when data related to machine control such as parameters is changed by an operator, the test management unit 201 receives a notification indicating function restrictions and restriction contents selected for the function that was changed along with the change in data (hereinafter also referred to as “changed-function notification”) from the numerical control device 10. The test management unit 201 outputs a test execution request to the test execution unit 202 described later to determine if the changed function would operate normally when a test is executed under a test environment where the selected function restriction works, even if an unexpected operation is executed in a machine tool (not illustrated) during the test for the safety of the machine tool and operators.

Based on the test results from the test execution unit 202, if the test results are normal (which means the changed function being in normal operation under the test environment), the test management unit 201 outputs a function restriction cancelation request to the numerical control device 10.

The test execution unit 202 tests whether the changed function would operate normally when a test is executed under a test environment where the selected function restriction works, based on the test execution request from the test management unit 201.

Specifically, for example, when the changed function is the safety speed limit monitoring function, which outputs an alarm and stops the shaft when the shaft speed of a machine tool (not illustrated) exceeds the set speed, the test execution unit 202 executes a test program, etc., under a test environment where the function restriction works to prohibit the door from opening, as described later, and outputs a signal of a test operation command for executing the safety speed limit monitoring function, to the numerical control device 10. The test execution unit 202 receives the operation result of the safety speed limit monitoring from the numerical control device 10, and outputs the received operation result as a test result to the test management unit 201.

### <Numerical Control Device 10>

The numerical control device 10 is a well-known numerical control device for those skilled in the art, and for example, generates operation commands, based on a machining program acquired from an external device such as a CAD/CAM device (not illustrated), and sends the generated operation commands to a machine tool (not illustrated). As a result, the numerical control device 10 controls the operation of the machine tool (not illustrated). Note that if the machine tool (not illustrated) is a robot, etc., the numerical control device 10 may be a robot control device, etc.

As illustrated in FIG. 1, the numerical control device 10 includes an input interface unit 110 as an input unit, a display unit 120, a storage unit 130, and a control unit 140. Further, the control unit 140 includes a changed-function extraction unit 141, a function restriction unit 142, and a function execution unit 143. The function restriction unit 142 includes a safety function execution unit 1421, an automatic operation execution unit 1422, and a manual operation execution unit 1423.

The input interface unit 110 is configured with, for example, a keyboard, MDI (Manual Data Input), and/or a touch panel arranged on the front surface of the display unit 120 described later, and receives input from the operator. The input interface unit 110 receives changes in data related to machine control such as parameters, ladder programs, machining programs, etc., based on the operator's input operation.

The display unit 120 is a display device such as an LCD (Liquid Crystal Display), and includes a touch panel (not illustrated) arranged on the front surface of the display device.

### <Storage Unit 130>

The storage unit 130 is a storage unit such as RAM or HDD. The storage unit 130 stores a function relationship table 131 and a function-restriction relationship table 132.

The function relationship table 131 is a table, in which the data related to machine control, such as parameters, ladder programs, machining programs, etc. is associated in advance with the machine control functions.

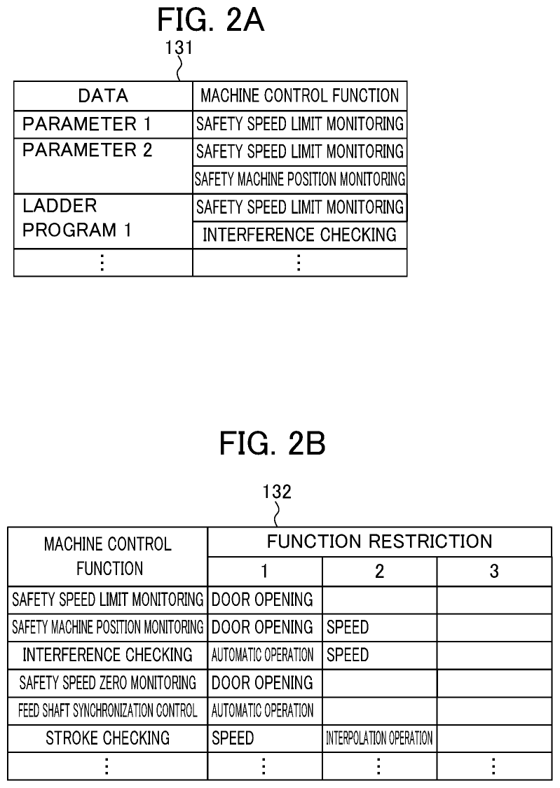

FIG. 2A is a diagram illustrating an example of the function relationship table 131.

As illustrated in FIG. 2A, the function relationship table 131 includes, for example, “Data” representing data related to machine control, and “Machine Control Function.”

The “Data” in the function relationship table 131 sets either the parameter, ladder program, or machining program etc., which are the data related to machine control and have been changed based on the operator's input operation. In FIG. 2A, “Parameter 1”, “Parameter 2”, “Ladder Program 1”, etc., may be set as the data.

The “Machine Control Function” in the function relationship table 131 is a function that is changed along with a change in the data related to machine control (for example, “Safety Speed Limit Monitoring”, “Safety Machine Position Monitoring”, etc.). FIG. 2A indicates that, for example, when the value of “Parameter 1” is changed, “Safety Speed Limit Monitoring” is changed; and when the value of “Parameter 2” is changed, both “Safety Speed Limit Monitoring” and “Safety Machine Position Monitoring” are changed. When “Ladder Program 1” is changed, both “Safety Speed Limit Monitoring” and “Interference Checking” are changed.

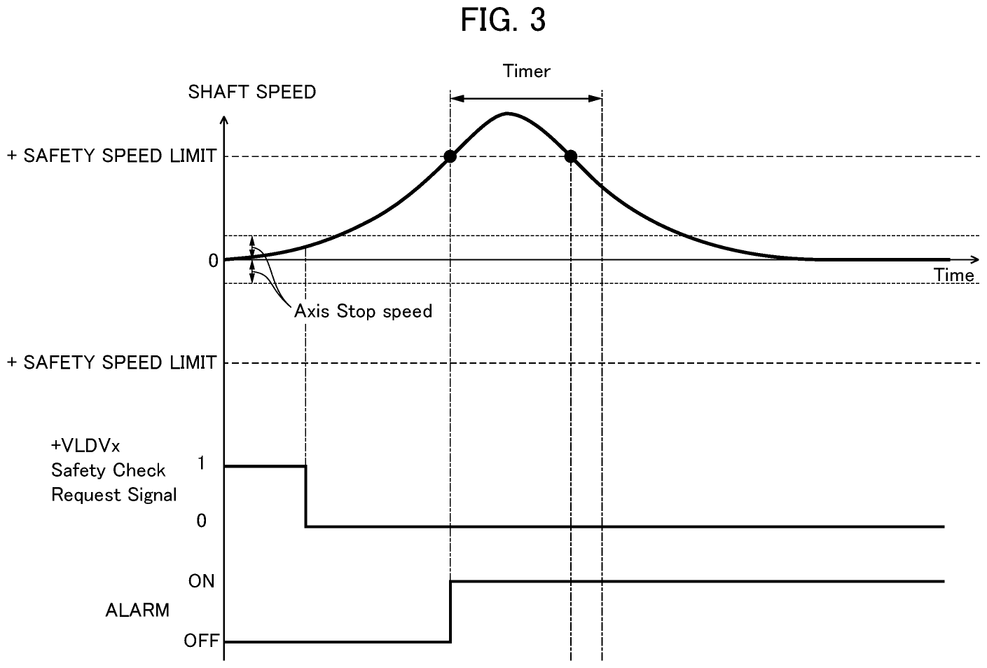

Here, as illustrated in FIG. 3, the function of “Safety Speed Limit Monitoring” is a safety function, which outputs an alarm and stops the shaft when the shaft speed exceeds the set speed; if the speed monitoring is not in normal operation, there is a risk of injury to the operator due to the shaft operating at high speed while the door is open; therefore, the function restriction operates to prohibit the door from opening.

The function of “Safety Machine Position Monitoring” is a safety function, which stops the shaft when the shaft position exceeds the set position; if the machine position monitoring is not in normal operation, there is a risk of injury to the operator due to the shaft moving in a range wider than expected, and a risk of the shaft colliding with installed objects; therefore, the door is prohibited from opening so as to ensure the operator's safety, and the maximum speed is limited so as to minimize the machine damage in the event of collision.

The function of “Interference Checking” is a function to check if the shaft would collide with jigs, etc.; if the interference checking is not in normal operation, there is an increased risk of machine damage and defective machining due to collisions; therefore, the maximum speed is reduced and the automatic operation is stopped so as to reduce the risk.

Note that the “Machine Control Function” in the function relationship table 131 may also include functions other than the above, such as “Safety Speed Zero Monitoring”, “Feed Shaft Synchronization Control”, and “Stroke Checking”.

The function-restriction relationship table 132 is a table, in which the functions to be changed along with a change in the data related to machine control are associated with the function restrictions to be executed on the functions changed.

FIG. 2B is a diagram illustrating an example of the function-restriction relationship table 132.

As illustrated in FIG. 2B, the function-restriction relationship table 132 includes, for example, “Machine Control Function”, and “Function Restriction” which is executed during the operation test of “Machine Control Function.”

“Machine Control Function” in the function-restriction relationship table 132 stores, for example, the functions such as “Safety Speed Limit Monitoring”, “Safety Machine Position Monitoring”, “Interference Checking”, “Safety Speed Zero Monitoring”, “Feed Shaft Synchronization Control”, and “Stroke Checking”.

“Function Restriction” in the function-restriction relationship table 132 stores one or more function restrictions to be executed on “Machine Control Function”. As an example of “Function Restriction” in FIG. 2B, “Safety Speed Limit Monitoring” stores the function restriction of “Door Opening” that restricts the door opening of the machine tool (not illustrated). “Safety Machine Position Monitoring” stores the function restrictions of “Door Opening”, and “Speed” that limits the shaft speed such as the maximum speed. “Interference Checking” stores the function restrictions of “Speed”, and “Automatic Operation” that restricts the automatic operation of the machine tool (not illustrated).

“Safety Speed Zero Monitoring”, may store the function restriction of “Door Opening”; “Feed Shaft Synchronization Control” may store the function restriction of “Automatic Operation”; and “Stroke Checking” may store the function restriction of “Speed” and “Interpolation Operation”. The function-restriction relationship table 132 in FIG. 2B illustrates three examples of “Function Restriction”, which are not limiting, and may be four or more.

### <Control Unit 140>

The control unit 140 includes CPU, ROM, RAM, CMOS (Complementary Metal-Oxide-Semiconductor) memory, etc., which are configured to be mutually communicable via a bus and well known to those skilled in the art.

The CPU is a processor that totally controls the numerical control device 10. The CPU reads the system program and application programs stored in the ROM via the bus, and controls the entire numerical control device 10 in accordance with the system program and application programs. As a result, as illustrated in FIG. 1, the control unit 140 is configured to implement the functions of the changed-function extraction unit 141, the function restriction unit 142, and the function execution unit 143; and the function restriction unit 142 is configured to implement the functions of the safety function execution unit 1421, the automatic operation execution unit 1422, and the manual operation execution unit 1423. Various data such as temporary calculation data and display data are stored in the RAM. The CMOS memory is backed up by a battery (not illustrated) and is configured as a non-volatile memory that retains the memory state even when the power of the numerical control device 10 is turned off.

The changed-function extraction unit 141 determines the functions related to the machine control data received by the input interface unit 110, based on the function relationship table 131.

Specifically, when the data received by the input interface unit 110 is “Parameter 1”, the changed-function extraction unit 141 determines that “Safety Speed Limit Monitoring” is the function changed by the change in “Parameter 1”. When the data received by the input interface unit 110 is “Parameter 2”, the changed-function extraction unit 141 determines that “Safety Speed Limit Monitoring” and “Safety Machine Position Monitoring” are the functions changed by the change in “Parameter 2”. When the data received by the input interface unit 110 is “Ladder Program 1”, the changed-function extraction unit 141 determines that “Safety Speed Limit Monitoring” and “Interference Checking” are the functions changed by the change in “Ladder Program 1”. The changed-function extraction unit 141 outputs the determination result as a changed-function notification to the function restriction unit 142.

The function restriction unit 142 selects one or more function restrictions, such as “Door Opening”, to be restricted when executing the operation test of the changed function (the determined function), based on the changed-function notification that indicates the result of determination by the changed-function extraction unit 141, and executes the selected function restriction.

Specifically, for example, when the changed-function notification from the changed-function extraction unit 141 indicates that “Safety Speed Limit Monitoring” is the changed function, the function restriction unit 142 selects the function restriction of “Door Opening” when executing the operation test of “Safety Speed Limit Monitoring”, based on the function-restriction relationship table 132. For example, when the changed-function notification from the changed-function extraction unit 141 indicates that “Safety Speed Limit Monitoring” and “Safety Machine Position Monitoring” are the changed functions, the function restriction unit 142 selects the function restriction of “Door Opening” when executing the operation test of “Safety Speed Limit Monitoring”, and selects the function restrictions of “Door Opening” and “Speed” when executing the operation test of “Safety Machine Position Monitoring”, based on the function-restriction relationship table 132. For example, when the changed-function notification from the changed-function extraction unit 141 indicates that “Safety Speed Limit Monitoring” and “Interference Checking” are the changed functions, the function restriction unit 142 selects the function restriction of “Door Opening” when executing the operation test of “Safety Speed Limit Monitoring”, and selects the function restrictions of “Automatic Operation” and “Speed” when executing the operation test of “Interference Checking”, based on the function-restriction relationship table 132.

The function restriction unit 142 notifies the test execution device 20 of the changed-function notification including the selected function restrictions and the restriction contents. When receiving a function restriction cancelation request from the test execution device 20 in response to the changed-function notification, the function restriction unit 142 cancels the function restriction executed in the operation test of the changed function.

The function restriction unit 142 may display the selected function restrictions and the restriction contents on the display unit 120 to notify the operator.

The safety function execution unit 1421, for example, executes the function restrictions when receiving the function restriction requests for “Door Opening”, “Speed”, “Position”, etc. from the function restriction unit 142.

The automatic operation execution unit 1422, for example, executes the function restrictions when receiving the function restriction requests for “Automatic Operation”, etc. from the function restriction unit 142.

The manual operation execution unit 1423, for example, executes the function restrictions when receiving the function restriction requests for “Manual Operation”, etc. from the function restriction unit 142.

The function execution unit 143 executes machine control over the machine tool (not illustrated), based on the data related to machine control.

### <Execution Processing by Automatic Test Execution System 1>

Next, the operation related to the control processing by the automatic test execution system 1 according to the first embodiment will be described.

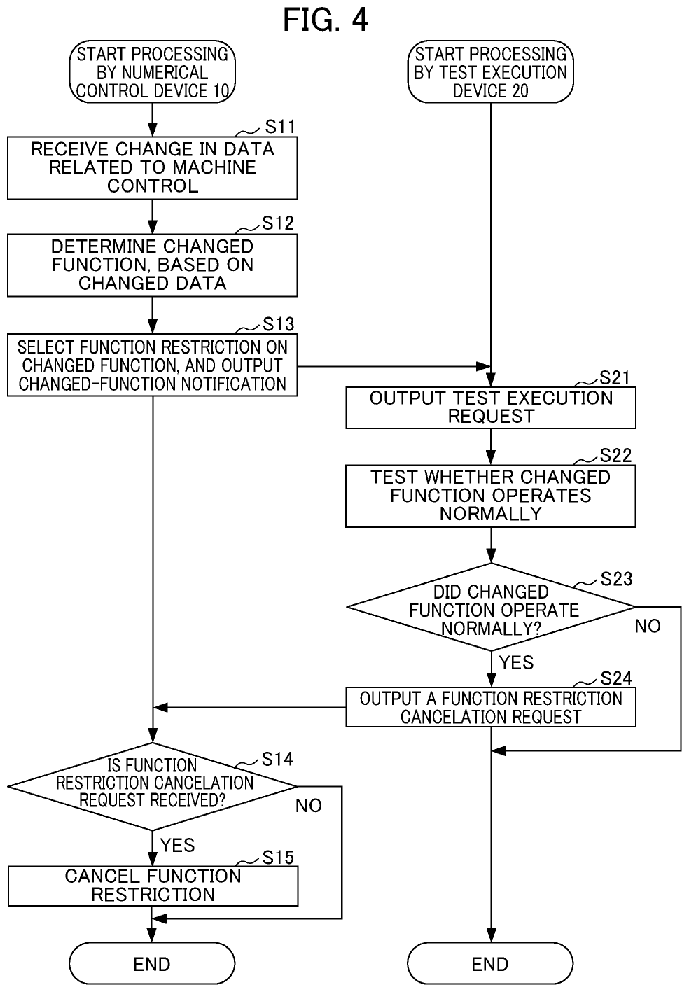

FIG. 4 is a flowchart illustrating the execution processing by the automatic test execution system 1. The flow illustrated here is executed each time the numerical control device 10 acquires a change in the data related to machine control from the operator.

In Step S11, the input interface unit 110 of the numerical control device 10 receives a change in the data related to machine control such as parameters, ladder programs, and machining programs, based on the operator's input operation.

In Step S12, the changed-function extraction unit 141 determines the changed function, based on the data received in Step S11 and the function relationship table 131.

In Step S13, the function restriction unit 142 selects a function restriction on the changed function, based on the changed-function notification indicating the determination result in Step S11 and the function-restriction relationship table 132, and outputs a changed-function notification including the selected function restrictions and the restriction contents to the test execution device 20.

In Step S21, the test management unit 201 of the test execution device 20 outputs a signal including a test execution request to the test execution unit 202 in order to determine whether the changed function would operate normally when the test is executed under a test environment where the selected function restriction works, based on the changed-function notification received from the numerical control device 10.

In Step S22, the test execution unit 202 tests whether the changed function would operate normally when the test is executed under the test environment where the selected function restriction works, based on the test execution request of Step S21.

In Step S23, the test management unit 201 determines whether the changed function has operated normally, based on the test result of Step S22. If the changed function has operated normally, the processing proceeds to Step S24. On the other hand, if the changed function has not operated normally, the test execution device 20 ends the processing.

In Step S24, the test management unit 201 outputs a function restriction cancelation request to the numerical control device 10.

In Step S14, the function restriction unit 142 of the numerical control device 10 determines whether a function restriction cancelation request has been received from the test execution device 20. If a function restriction cancelation request has been received, the processing proceeds to Step S15. On the other hand, if a function restriction cancelation request has not been received, the numerical control device 10 ends the processing.

In Step S15, the function restriction unit 142 cancels the function restriction that was executed in the operation test of the changed function.

Thus, the numerical control device 10 according to the first embodiment determines the changed function when receiving the change in the data related to machine control by the operator, selects a function restriction on the changed function, and outputs a changed-function notification including the selected function restrictions and the restriction contents to the test execution device 20. When receiving a function restriction cancelation request from the test execution device 20, the numerical control device 10 cancels the function restriction that was executed in the operation test of the changed function.

As a result, the numerical control device 10 can reduce the risk of executing unexpected operations when the operator changes the data related to machine control.

The first embodiment has been described above.

### Second Embodiment

Next, the second embodiment will be described. As mentioned above, in the first embodiment, when canceling the executed function restriction, the numerical control device 10 is connected to the test execution device 20 that manages and executes a test for each function, the test execution device 20 executes the test for each function in response to the changed-function notification from the numerical control device 10, and the numerical control device 10 cancels the function restriction in response to a function restriction cancelation request from the test execution device 20 indicating the test result being normal. In contrast, the second embodiment differs from the first embodiment in that a numerical control device 10A displays a changed-function notification including function restrictions and restriction contents, and cancels the function restrictions in response to a function restriction cancelation request from the operator.

As a result, the numerical control device 10A can reduce the risk of executing unexpected operations when the operator changes the data related to machine control.

The second embodiment is described below.

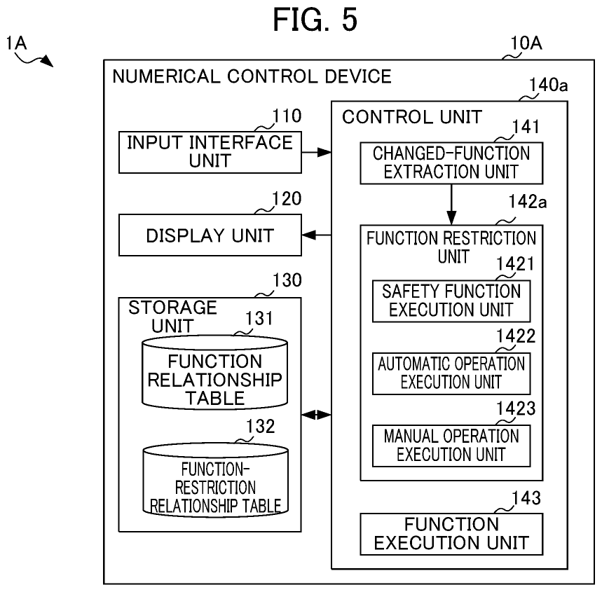

FIG. 5 is a functional block diagram illustrating an example of a functional configuration of the control system according to the second embodiment. Note that the same reference numerals are assigned to elements having the same functions as the elements of the automatic test execution system 1 in FIG. 1, and detailed description is omitted.

As illustrated in FIG. 5, the control system 1A includes a numerical control device 10A.

### <Numerical Control Device 10A>

The numerical control device 10A according to the second embodiment has a configuration equivalent to the numerical control device 10 of the first embodiment.

That is, as illustrated in FIG. 5, the numerical control device 10A includes an input interface unit 110, a display unit 120, a storage unit 130, and a control unit 140a. The control unit 140a includes a changed-function extraction unit 141, a function restriction unit 142a, and a function execution unit 143. The function restriction unit 142a includes a safety function execution unit 1421, an automatic operation execution unit 1422, and a manual operation execution unit 1423. The storage unit 130 stores a function relationship table 131, and a function-restriction relationship table 132.

The changed-function extraction unit 141 and the function execution unit 143 have the functions equivalent to the changed-function extraction unit 141 and function execution unit 143 of the first embodiment.

The safety function execution unit 1421, the automatic operation execution unit 1422, and the manual operation execution unit 1423 have the functions equivalent to the safety function execution unit 1421, the automatic operation execution unit 1422, and the manual operation execution unit 1423 of the first embodiment.

The function relationship table 131, and the function-restriction relationship table 132 are the data equivalent to the function relationship table 131, and the function-restriction relationship table 132 of the first embodiment.

As in the case with the function restriction unit 142 of the first embodiment, the function restriction unit 142a selects and executes one or more function restrictions, such as “Door Opening”, which are executed when checking the operation of the changed function, based on the changed-function notification indicating a result of determination by the changed-function extraction unit 141.

Specifically, when the changed-function notification from the changed-function extraction unit 141 indicates that “Safety Speed Limit Monitoring” is the changed function, the function restriction unit 142a selects and executes the function restriction of “Door Opening” when checking the operation of “Safety Speed Limit Monitoring”, based on the function-restriction relationship table 132. For example, when the changed-function notification from the changed-function extraction unit 141 indicates that “Safety Speed Limit Monitoring” and “Safety Machine Position Monitoring” are the changed functions, the function restriction unit 142a selects the function restriction of “Door Opening” when checking the operation of “Safety Speed Limit Monitoring”, and selects and executes the function restrictions of “Door Opening” and “Speed” when checking the operation of “Safety Machine Position Monitoring”, based on the function-restriction relationship table 132. For example, when the changed-function notification from the changed-function extraction unit 141 indicates that “Safety Speed Limit Monitoring” and “Interference Checking” are the changed functions, the function restriction unit 142a selects the function restriction of “Door Opening” when checking the operation of “Safety Speed Limit Monitoring”, selects the function restrictions of “Automatic Operation” and “Speed” when executing operation of “Interference Checking”, and executes the function restrictions of “Door Opening”, “Automatic Operation”, and “Speed”, based on the function-restriction relationship table 132.

The function restriction unit 142a displays a changed-function notification including the selected function restrictions and restriction contents on the display unit 120.

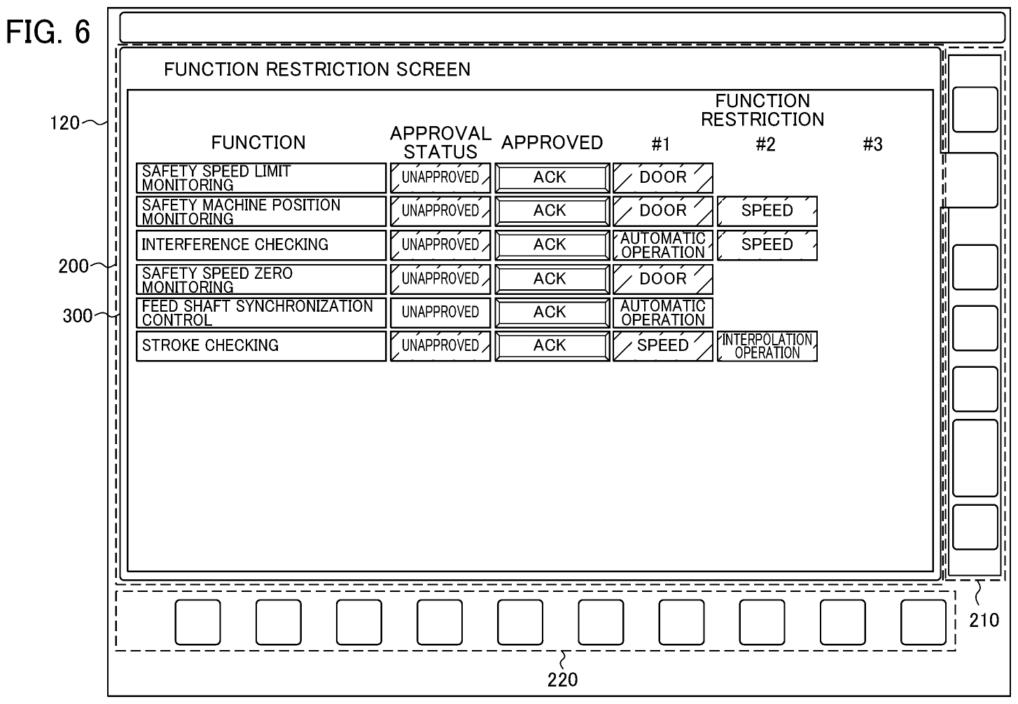

FIG. 6 is a diagram illustrating an example of a display screen 300 displayed on the display unit 120.

As illustrated in FIG. 6, the display unit 120 includes a region 200 that displays the display screen 300, a region 210 that displays, for example, eight selection keys for selecting a display screen, and a region 220 that displays ten or so softkeys.

The display screen 300 is a function restriction screen, and displays, for example in the first column, the changed functions such as “Safety Speed Limit Monitoring”, “Safety Machine Position Monitoring”, “Interference Checking”, “Safety Speed Zero Monitoring”, “Feed Shaft Synchronization Control”, “Stroke Checking”, etc. The second column of the display screen 300 displays the approval status (such as “Unapproved” or “Approved”) for each changed function, indicating whether cancelation of the function restriction has been approved by the operator. The third column of the display screen 300 displays the ACK button for each changed function, which is pressed by the operator operating the input interface unit 110 when approving the cancelation of the function restriction. The fourth to sixth columns of the display screen 300 display the function restrictions that are set for the changed function.

For instance, the operator visually verifies that the shaft correctly stops when the speed exceeds the speed set in “Safety Speed Limit Monitoring” when operating under the operating environment where the function restriction of “Door Opening” works, and on the display screen 300, the operator presses the ACK button by operating the input interface unit 110, thereby outputting a function restriction cancelation request to the function restriction unit 142a to cancel the function restriction of “Door Opening”. The operator visually verifies that the shaft correctly stops when the shaft position exceeds the position set in “Safety Machine Position Monitoring” when operating under the operating environment where the function restrictions of “Door Opening” and “Speed” work, and the operator presses the ACK button by operating the input interface unit 110, thereby outputting a function restriction cancelation request to the function restriction unit 142a to cancel the function restrictions of “Door Opening” and “Speed”. The operator visually verifies that the shaft does not collide with jigs, etc. in “Interference Checking” when operating under the operating environment where the function restrictions of “Automatic Operation” and “Speed” work, and the operator presses the ACK button by operating the input interface unit 110, thereby outputting a function restriction cancelation request to the function restriction unit 142a to cancel the function restrictions of “Automatic Operation” and “Speed”.

Note that in the display screen 300 of FIG. 6, the second column displays the approval status of “Unapproved” as shaded and “Approved” as unshaded; however, the approval status may be displayed in color such as “Unapproved” in red and “Approved” in yellow. In the display screen 300, the fourth to sixth columns display the function restrictions with the approval status in the second column of “Unapproved” as shaded and “Approved” as unshaded; however, the function restrictions may be displayed in color such as “Unapproved” in red and “Approved” in yellow.

When the operation of the changed function is checked and determined, the function restriction is executed in response to the changed-function notification, the ACK button is pressed by the operator operating the input interface unit 110, and the function restriction unit 142a receives the function restriction cancelation request, then the function restriction unit 142a cancels the function restriction that was executed when checking the operation of the changed function.

### <Control Processing by Numerical Control Device 10A>

Next, the operation related to the control processing by the numerical control device 10A according to the second embodiment will be described.

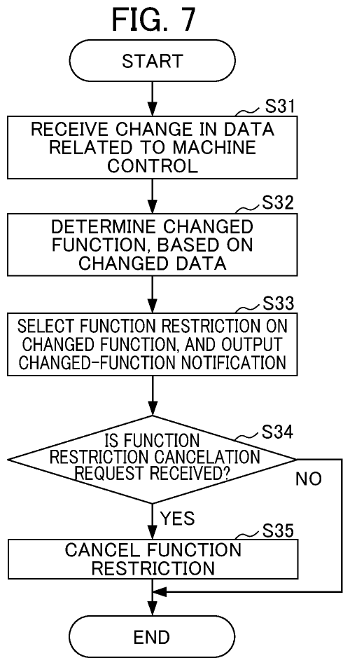

FIG. 7 is a flowchart illustrating the control processing by the numerical control device 10A. The flow illustrated here is executed each time the numerical control device 10A acquires a change in data related to machine control from the operator.

Note that the processing in Steps S31, S32, and S35 are similar to Steps S11, S12, and S15 of the first embodiment illustrated in FIG. 3, so the description is omitted.

In Step S33, based on the changed-function notification indicating the result of determination in Step S31 and the function-restriction relationship table 132, the function restriction unit 142a selects the function restriction on the changed function, and outputs a changed-function notification including the selected function restriction and the restriction contents to the display unit 120 that displays the screen 300 illustrated in FIG. 6.

In Step S34, the function restriction unit 142a determines whether a function restriction cancelation request has been received as a result of the ACK button being pressed by the operator who verified that the changed function operates normally when operated under the environment where the function restriction works. If a function restriction cancelation request has been received, the processing proceeds to Step S35. On the other hand, if a function restriction cancelation request has not been received, the numerical control device 10A terminates the processing.

In this manner, the numerical control device 10A according to the second embodiment determines a changed function when receiving a change in data related to machine control by the operator, selects the function restriction on the changed function, and displays a changed-function notification including the selected function restriction and the restriction contents on the display unit 120. When receiving a function restriction cancelation request based on the operator's input operation, the numerical control device 10A cancels the function restriction that was executed when checking the operation of the changed function.

As a result, the numerical control device 10A can reduce the risk of executing unexpected operations when the operator changes the data related to machine control.

The second embodiment has been described above.

The first and second embodiments have been described above; however, the numerical control devices 10 and 10A are not limited to the above embodiments, and include modifications and improvements within the scope that can achieve the objectives.

### Modification Example 1

In the first and second embodiments, when receiving changes in data related to machine control by the operator, the numerical control devices 10 and 10A select all the function restrictions (such as “Door Opening” and “Speed” in “Safety Machine Position Monitoring”) that execute all the selected function restrictions when testing (or checking) the operation of the changed functions, and cancel all the function restrictions when receiving a function restriction cancelation request; however, this is not limited. For instance, the numerical control devices 10 and 10A may select and execute one function restriction at first from among the plurality of function restrictions (for example, “Door Opening” and “Speed” in “Safety Machine Position Monitoring”, etc.) on the changed functions, and cancel this function restriction when receiving the function restriction cancelation request. Next, the numerical control devices 10 and 10A may select and execute another function restriction from among the remaining function restrictions and cancel this function restriction when receiving the function restriction cancelation request, by handling individual cases separately.

### Modification Example 2

In the first and second embodiments, when receiving changes in data related to machine control by the operator, the numerical control devices 10 and 10A select the function restrictions on the changed functions; however, this is not limited. For instance, the operator may be allowed to select the function restrictions on the changed functions.

### Modification Example 3

In the first embodiment, the test execution device 20 has been described as a device different from the numerical control device 10; however, this is not limited. For example, the test execution device 20 may be included in the numerical control device 10.

Note that each function included in the numerical control devices 10 and 10A according to the first and second embodiments can be implemented by hardware, software, or a combination thereof. Here, implementation by software refers to implementation achieved by a computer loading and executing a program.

The program can be stored using various types of non-transitory computer-readable media, and can be provided to a computer. Non-transitory computer-readable media include various types of tangible storage media. Examples of non-transitory computer-readable media include magnetic recording media (such as flexible disks, magnetic tapes, hard disk drives), magneto-optical recording media (such as magneto-optical disks), CD-ROM (Read Only Memory), CD-R, CD-R/W, and semiconductor memories (such as mask ROM, PROM (Programmable ROM), EPROM (Erasable PROM), flash ROM, RAM). The program may be provided to a computer via various types of transitory computer-readable media. Examples of transitory computer-readable media include electrical signals, optical signals, and electromagnetic waves. Transitory computer-readable media can supply a program to a computer via wired communication paths such as electrical wires and optical fibers, or via wireless communication paths.

Note that the steps describing a program to be recorded on a recording medium include not only processing executed chronologically in accordance with the order, but also processing that does not necessarily have to be executed chronologically, and can include processing executed in parallel or individually.

In other words, the control device of the present disclosure can take various types of embodiments having configurations as follows.
(1) The numerical control device 10, 10A of the present disclosure includes: the input interface unit 110 configured to externally receive data related to machine control; the changed-function extraction unit 141 configured to determine a function related to the data received by the input interface unit 110; the function restriction unit 142, 142a configured to select and execute one or more function restrictions, based on the changed-function notification indicating the result of determination by the changed-function extraction unit 141; and the function execution unit configured to executes machine control.

With the numerical control device 10, 10A described above, the risk of executing unexpected operations can be reduced when the operator changes the data related to machine control.
(2) In the numerical control device 10, 10A described in (1), the data may include at least one of parameters, a ladder program, or a machining program.

As a result, the numerical control device 10, 10A can reduce the risk of executing unexpected operations with high accuracy, in accordance with the changed data.
(3) In the numerical control device 10, 10A described in (1) or (2), the function restriction unit 142, 142a may externally notify the selected function restrictions and the restriction contents.

As a result, the numerical control device 10, 10A can allow the test execution device 20 or the operator to determine whether the function restriction is operating normally.
(4) In the numerical control device 10, 10A described in any one of (1) to (3), the function restriction may be canceled when a function restriction cancelation request is externally received.

As a result, the numerical control device 10, 10A can cancel the function restriction without executing unexpected operations.
(5) In the numerical control device 10 described in (3), the function restriction unit 142 may notify the test execution device 20 of the changed-function notification including the selected function restrictions and the restriction contents, and may allow the test execution device 20 to test whether the changed function (determined function) operates normally.

As a result, the numerical control device 10 can reduce the load on the operator by allowing the test execution device 20 to test whether the function restriction is operating normally.
(6) In the numerical control device 10 described in (5), when the test execution device 20 has verified that the changed function (determined function) is operating normally, and a function restriction cancelation request to cancel the selected function restriction is received from the test execution device 20, the function restriction unit 142 may cancel the function restriction.

As a result, the numerical control device 10 can achieve the same effects as described in (4).
(7) The numerical control device 10A described in (3) includes the display unit 120, in which the function restriction unit 142a may display a changed-function notification including the selected function restrictions and the restriction contents on the display unit 120.

As a result, the numerical control device 10A can notify the operator of the changed function and the function contents when the data related to machine control is changed by the operator.
(8) In the numerical control device 10A described in (7), the input interface unit 110 may receive a function restriction cancelation request to cancel the selected function restriction, upon verifying that the changed function (determined function) is operating normally, and the function restriction unit 142a may cancel the selected function restriction.

As a result, the numerical control device 10 can achieve the same effects as described in (4).
(9) In the numerical control device 10, 10A described in (4), when a plurality of function restrictions are selected, the function restriction unit 142, 142a may individually cancel each function restriction, based on a function restriction cancelation request to cancel each function restriction.

As a result, the numerical control device 10, 10A can cancel each function restriction individually.

### EXPLANATION OF REFERENCE NUMERALS

1: automatic test execution system
1A: control system
10, 10A: numerical control device
110: input interface unit
120: display unit
130: storage unit
131: function relationship table
132: function-restriction relationship table
140, 140a: control unit
141: changed-function extraction unit
142, 142a: function restriction unit
143: function execution unit
20: test execution device
201: test management unit
202: test execution unit

1. A control device, comprising:
an input unit configured to externally receive data related to machine control;
a changed-function extraction unit configured to determine a function related to the data received by the input unit;
a function restriction unit configured to select one or more function restrictions and execute the function restrictions selected, based on a changed-function notification indicating a result of determination by the changed-function extraction unit; and
a function execution unit configured to execute the machine control.

2. The control device according to claim 1, wherein the data includes at least one of a parameter, a ladder program, or a machining program.

3. The control device according to claim 1, wherein the function restriction unit externally notifies the function restrictions selected and restriction contents.

4. The control device according to claim 1, wherein the function restriction unit cancels the function restrictions upon externally receiving a function restriction cancelation request.

5. The control device according to claim 3, wherein the function restriction unit notifies a test execution device of a changed-function notification including the function restrictions selected and the restriction contents, and causes the test execution device to test whether the function determined operates normally.

6. The control device according to claim 5, wherein the function restriction unit cancels the function restrictions selected, when the test execution device has verified that the function determined operates normally, and a function restriction cancelation request to cancel the function restrictions selected is received from the test execution device.

7. The control device according to claim 3, further comprising:
a display unit,
wherein the function restriction unit displays the changed-function notification including the function restrictions selected and the restriction contents on the display unit.

8. The control device according to claim 7,
wherein, upon verifying that the function determined operates normally, the input unit receives a function restriction cancelation request to cancel the function restrictions selected, and
wherein the function restriction unit cancels the function restrictions selected.

9. The control device according to claim 4, wherein, when a plurality of function restrictions are selected, the function restriction unit individually cancels each of the function restrictions, based on the function restriction cancelation request to cancel each of the function restrictions.
